(19) United States
(12) Patent Application Publication
(10) Pub. No.: US 2004/0229633 A1
(43) Pub. Date: Nov. 18, 2004

(54) Interface device for GPS receiver

(76) Inventor: Ossian Riday, Topsham, ME (US)

Correspondence Address: BOHAN, MATHERS & ASSOCIATES, LLC, PO BOX 17707, PORTLAND, ME, 04112-8707, US

(21) Appl. No.: 10/843,736

(22) Filed: May 12, 2004

Related U.S. Application Data
(60) Provisional application No. 60/469,713, filed on May 12, 2003.

(51) Int. Cl. H04Q 7/20

(52) U.S. Cl. 455/456.6; 455/550.1

(57) ABSTRACT

An interface device for functionally connecting a universal GPS receiver with another electronic device. The interface device supports the GPS receiver in a manner that ensures a functional connection between the GPS receiver and the interface device. A battery pack and circuitry providing additional functionality, such as for a data logger, wireless communication with an external device, etc. are provided within the housing of the interface device. The interface device further includes an external connector for connecting to a DC power adapter.

### BACKGROUND INFORMATION

1. Field of the Invention

The invention relates to the field of electronic data and/or communication devices. Particularly, the invention relates to an interface device for supporting a GPS receiver and providing the functionality of a battery pack and/or one or more other electronic devices.

2. Description of the Prior Art

The demand for geographic position information is rapidly increasing with the emergence of new markets and technologies, and the number and type of applications for global positioning systems (GPS) are inceasing to meet this demand. Many such applications link GPS data with data from other sources, and in the few years since GPS systems and GPS devices have been accessible and available for general use, the demands of users of GPS devices have evolved from that of using a GPS device that simply displays position information to a need for marrying position information from a GPS system with data from other sources. As the availability and use of inexpensive GPS receivers expands, the number and variety of applications for GPS data and devices will also increase, as will the need to connect a GPS receiver with other devices in order to exchange, evaluate, or process data.

It is often desirable or necessary to connect the GPS receiver to a data logging device or other electronic device to enable evaluation and processing of the GPS data by a remote system. For example, when working in the field and collecting data that is linked to a geographic position, a user will typically connect a GPS receiver to a data logger. The GPS receiver is also commonly used today in Automated Vehicle Location (AVL) to track each vehicle in a fleet of vehicles. Here, too, the GPS receiver is connected to a data logger and the data is transmitted via radio back to the monitoring station at a remote location. In another application, the GPS receiver is connected to a dashboard computer in order to operate a road map computer program.

Today, if a user would like to connect a GPS receiver to another electronic device or power source, he has two choices. The first choice is to buy an all-in-one package that includes a GPS receiver and the particular additional electronic device, for example, a power pack, or a data logger. There are several disadvantages to this approach: for one, such GPS packages are relatively expensive; and for another, it is not possible to quickly and easily add additional devices to the package. The second choice is to buy an inexpensive GPS receiver and to add the additional electronic devices via a cable connection. The disadvantages with this approach are that the setup may be too complicated for the technologically unsophisticated to configure properly, and the resulting combination of devices be unwieldy and difficult to carry because the user has to deal with two or more devices that are linked by a flexible cable. When working in the field under improvisational conditions, it may be difficult to use and transport devices so connected in a manner that ensures an uninterrupted functional connection.

What is needed therefore is an interface device that provides the ability to link a GPS receiver with various other functionalities. What is further needed is such an interface device that incorporates a power pack and/or the functionality of another electronic device. What is yet further needed is such an interface device that provides a secure connection and mount for the GPS receiver.

### BRIEF SUMMARY OF THE INVENTION

For the above-cited reasons, it is an object of the present invention to provide an interface device that enables one to link a GPS receiver with one or more various other functionalities. It is a further object to provide such an interface device that incorporates a power pack and/or the additional functionality of another electronic device. It is a yet further object to provide such a device that provides a secure connection and mount for the GPS receiver.

The objects are achieved by providing an interface device that mates with the universal GPS receiver that is disclosed in U.S. utility patent application Ser. No. 10/655,937, filed on Sep. 5, 2003. The entire disclosure of that patent application is incorporated herein by reference. The interface device provides a secure mount for the GPS receiver and has a receiver connector that mates with the connector on the GPS receiver. Enclosed within the housing of the interface device is a battery pack and/or internal circuitry for one or more functions, such as that of a data logger. Also provided in the housing is an external connector for connecting the GPS receiver via the interface device to an external DC power adapter.

Several types of mounts are possible for holding the GPS receiver in a fixed position relative to the interface device. For example, the mount may be configured as a sled or a pocket that provides a form-positive base that cradles the GPS receiver and allows it to snap into place, simultaneously functionally engaging the mating parts of the connector on the GPS receiver and the interface device. In another configuration, the mount may provide a bayonet-type mount having a rail over which the GPS receiver slides until the receiver snaps into position, again, simultaneously functionally engaging the GPS receiver connector on the interface device with the mating connector part on the GPS receiver. Ideally, some means of locking the GPS receiver into position is provided on the mount. Such means include any number of well-known mechanical latch or snap mechanisms. The key feature of the mount is that it provides a secure and substantially rigid means of holding the GPS receiver in a position that ensures a functional connection with the GPS receiver connector on the interface device.

The interface device according to the invention is provided in various configurations to accommodate the specific needs of the GPS receiver user. It is envisioned that the GPS receiver user acquire a universal GPS receiver and then, as the need arises, acquire one or more interface devices that provide specific functionalities. For example, the user who needs to link the GPS receiver with a data logger will acquire an interface device that provides a battery pack and a data logger. Similarly, the user may purchase any number of additional interface devices that provide other specific functionalities, such as that of Family Radio Service (FRS) walkie-talkie communication; short-range digital two-way radio communication, such as Bluetooth®; wireless LAN communication, such as the 802.11 protocol; cellular wireless modules for data and/or voice; or a digital camera, a digital compass, a barometer, a solar cell, voice recognition and text to speech conversion, etc.

In addition to the internal circuitry and an external DC adapter connector, the device may also be provided with an alternative energy source, such as solar cells, to power the GPS receiver and other circuitry incorporated in the interface device. In the solar-powered configuration, a layer of solar cells is mounted on the top surface of the housing of the interface device. When the device is left on the dash of the vehicle, exposed to the rays of the sun, it automatically recharges, so that the GPS receiver and device are charged and ready for the next foray into the field.

### BRIEF DESCRIPTION OF THE DRAWINGS

The present invention is described with reference to the accompanying drawings. In the drawings, like reference numbers indicate identical or functionally similar elements.

FIG. 1 is a perspective view of the universal GPS receiver.

FIG. 2 is a perspective view of the preferred embodiment of the interface device according to the present invention.

FIG. 3 is perspective view showing the GPS receiver of FIG. 1 mounted on the interface device of FIG. 2.

FIG. 4 is a view of the underside of the interface device of FIG. 2 and showing battery pack configurations.

FIG. 5 is a schematic diagram of the interface device according to the invention, configured as a battery pack and with circuitry for Bluetooth communication.

FIG. 6 is a top view of an alternative embodiment of the interface device according to the invention.

FIG. 7 is a side view of the interface device of FIG. 6, connected with a universal GPS receiver.

FIG. 8 is a top view of the GPS receiver and the PDA interface device.

FIG. 9 is a side view of the PDA interface device of FIG. 8.

FIG. 10 is a schematic illustration of the interface device of FIG. 8.

### DETAILED DESCRIPTION OF THE INVENTION

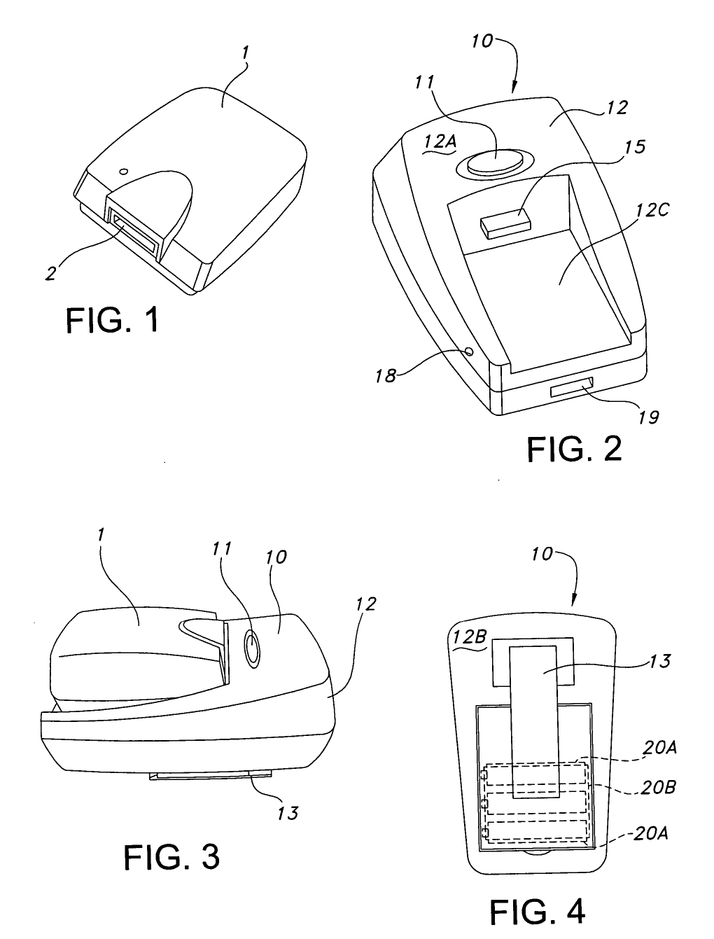

FIG. 1 shows a universal GPS receiver 1 that is described in the patent application Ser. No. 10/655,937. The universal GPS receiver 1 has a multi-mode connector 2.

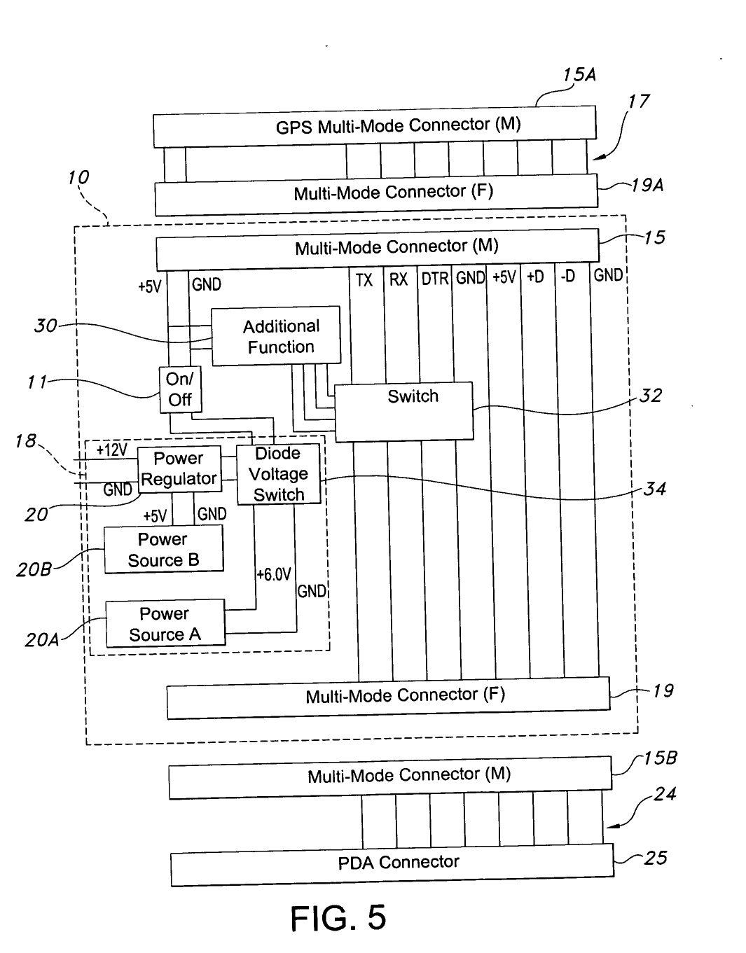

FIGS. 2-5 illustrate the preferred embodiment of an interface device 10 according to the invention. FIG. 2 is a perspective top view of the interface device 10; FIG. 3 a perspective side view showing the GPS receiver 1 mounted in the interface device 10; FIG. 4 a view of the bottom of the interface device 10; and FIG. 5 a schematic diagram of the internal circuitry of the interface device 10. The GPS receiver 1 is mountable on the interface device 10, such that the GPS receiver 1 receives power from and transmits data to the interface device 10. The interface device 10 includes a GPS receiver connector 15, an external power connector 18, a battery pack 20 and, preferably, the functionality of at least one other electronic device, such as a data logger, short-range two-way radio communication (for example, Bluetooth®), etc. The GPS receiver connector 15 mates with interface device connector 2 on the GPS receiver 1 and establishes an electronic connection between the two devices. The external power connector 18 allows an external DC power source to be connected to the interface device 10. In addition, an external-device connector 19 is provided on the interface device 10 for connecting the interface device 10 to a computing device such as a PDA or a PC. The connectors 15 and 19 are multi-mode connectors having at least 6 pins (2 for the USB signal, 2 for the RS-232 signal, 1 for GND and 1 for power). A multi-mode connector with 12 pins was used in the embodiment shown. The interface device 10 has a housing, which includes an upper housing 12A, a lower housing 12B, and a support bed 12C for receiving the GPS receiver 1. When the GPS receiver 1 is properly seated on the support bed 12C, the interface device 10 and the GPS receiver 1 are electronically connected and data exchange between the two devices is possible. An ON/OFF switch 11 is provided on the housing 12 for switching current flow through the interface device 10 on or off.

FIG. 4 also illustrates an arrangement of replaceable batteries 20A or rechargeable batteries 20B in the battery pack 20. The interface device 10 as illustrated in FIG. 5 is also provided with additional device circuitry 30 for providing at least one additional function. The device circuitry 30 in the particular embodiment shown provides an additional function, for example, Bluetooth® wireless communication capability, which may be used to communicate with another external device, such as a PDA. An internal switch 32 is provided for switching off the additional function 30 when a PDA connector 24 is connected to the external-device connector 19. This is done in the preferred embodiment to prevent the interface device 10 from communicating with more than one external device, for reasons of simplicity and power conservation. It is within the scope of the invention to eliminate this switch 32, depending on the intended use of the interface device 10. Also, Bluetooth® is mentioned only as an example of an additional function that may be provided by the interface device 10 according to the invention. As mentioned earlier, other possible and useful functions include that of a data logger, Family Radio Service (FRS) walkie-talkie communication, 802.11, cellular wireless modules for data and/or voice, a digital camera, a digital compass, a barometer, a solar cell, voice recognition and text to speech conversion, etc.

The battery pack 20 may be a plurality of AAA batteries 20A or a single brick-type rechargeable battery 20B. As illustrated in FIG. 5, the battery pack 20 includes a voltage switch 34 that will automatically switch the power source from battery operation to DC power operation when a DC power source is supplied through the external connector 18. In addition to the battery pack 20, an alternative energy source, such as a commercially available solar power panel, may be connected to the interface device 10 via the external power connector 18.

In many uses of the GPS receiver 1, it may be desirable to carry the GPS receiver 1 in a location separate from the interface device 10. For example, a user who is using the GPS receiver 1 as guide during hiking activities may prefer to carry the GPS receiver 1 on his head and to carry the interface device 10 elsewhere on his person or in a backpack. For this reason, an extension cable 17 is provided to connect the GPS receiver 1 to the interface device. The extension cable 17 is shown only schematically in FIG. 5. A multi-mode GPS receiver connector 15A is connected to one end and a multi-mode interface device connector 19A connected to the other end of the extension cable 17. The length of the extension cable 17 may be any suitable length. The interface device 10 is provided with a detachable belt clip 13, as illustrated in FIGS. 3 and 4, for clipping it to a belt or strap.

It is possible to connect the interface device 10 to an external computer device, such as a PDA or a PC via the external-device connector 19. A PDA connector cable 24 used for this purpose has a multi-mode connector 15B on one end that mates with the external-device connector 19 on the interface device 10 and a PDA connector 25 at the other end that connects with the PC or PDA device. PDA connectors vary in geometry and number of pins according to the brand of PDA, thus, the PDA connector cable 24 is specific to the type of PDA connector.

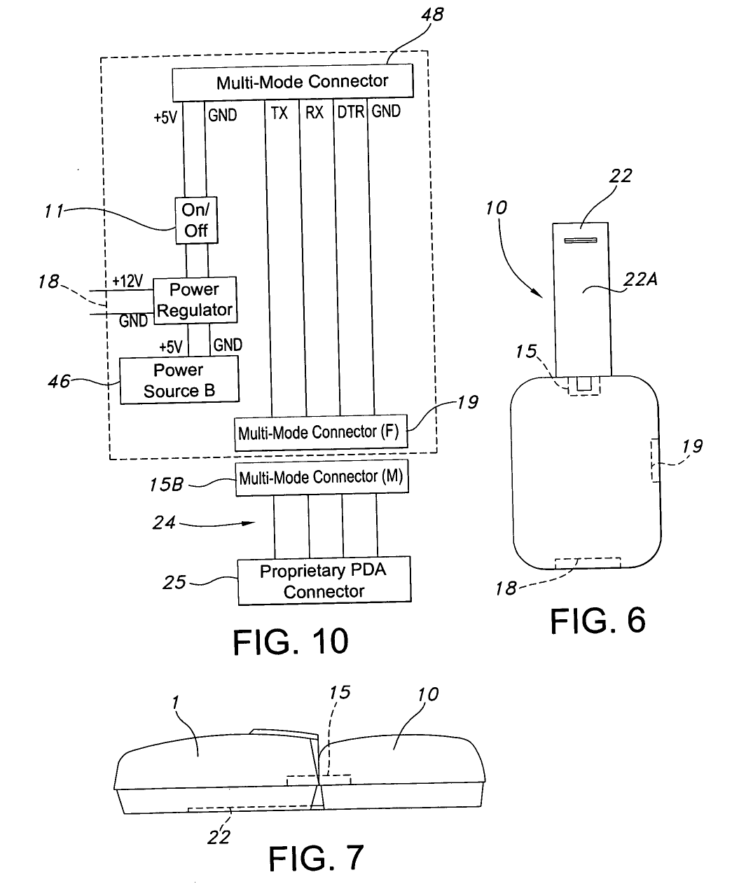

In another embodiment of an interface device 10A according to the invention, as shown in FIGS. 6 and 7, a mount 22 firmly and securely attaches to the GPS receiver 1 in such a way that the receiver connector 15 mates with and establishes an electronic connection with the external connector provided on the GPS receiver 1. In the embodiment shown, the mount 22 is a bayonet-type connector, having a rigid rail 22A that protrudes from the housing 12 of the interface device 10. The housing of the GPS receiver 1 is adapted to receive the rigid rail 22A. As shown in FIG. 6, a rail support contour 22B is formed in the bottom of the housing, into which the rigid rail 22A is insertable. Preferably, a locking means is provided that locks the GPS receiver 1 in position on the interface device 10 so that it is not easily unintentionally disconnected. Such suitable locking means are numerous and well known in the field. One such means is a snap combination that includes a pawl or protrusion that snaps into a detente on the mating part. For example, the detente is provided on the rigid rail 22A and the mating part is provided in the rail support 22B on the GPS receiver 1.

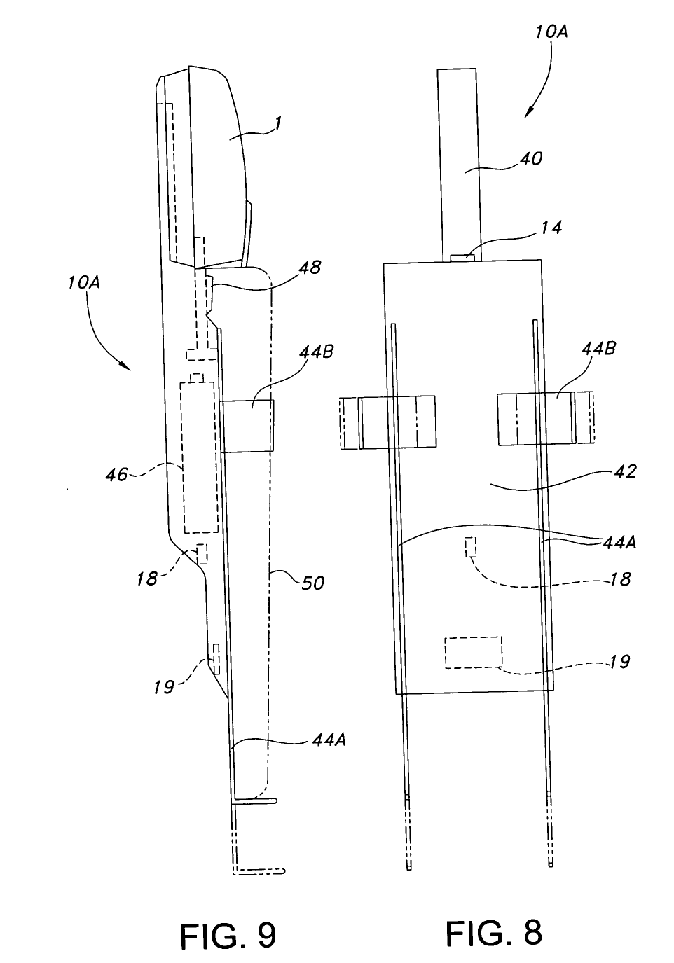

FIGS. 8-10 illustrate a PDA interface device 10B according to the invention that provides a connection between the GPS receiver 1 and a conventional Personal Digital Assistant (PDA) 50 (shown with dashed lines in FIG. 9). The interface device 10A has a receiver connector 14 that mates with the connector 2 on the GPS receiver 1 and an external connector 18 for connecting the interface device 10A to an external DC power adapter. The PDA interface device 10A has a GPS receiver mount 40 for supporting the GPS receiver 1 and a PDA mount 42 for supporting a PDA. Various models of PDAs are available and they all may have slightly different shapes and sizes. Accordingly, the PDA mount 42 is designed to accommodate various sizes and shapes. The PDA mount 42 includes a first set of mounting brackets 44A that are adjustable lengthwise and a second set of mounting brackets 44B that are adjustable widthwise. A GPS-receiver connector 48 that mates with the device connector 2 on the GPS receiver 1 is provided on the PDA mount 42. Connecting the GPS receiver 1 to the GPS receiver connector 48 locks the GPS receiver 1 into position on and establishes an electronic connection with the PDA interface device 10B. A short PDA cable 24 is provided to electronically connect the PDA interface device 10B with the PDA being used. The cable 24 is shown in FIG. 10 only. In this embodiment, the external-device connector 19 is provided on the underside of the interface device 10A. The multi-mode connector 15B plugs into the external-device connector 19 and the PDA connector 25 into the conventional connector provided on the PDA device 50. As mentioned earlier, the connectors on PDAs vary in geometry and in the number of pins with the brand of device, thus, the cable 24 is constructed to connect to a particular PDA connector. FIG. 8 shows the GPS receiver 1 connected to the PDA interface device 10B. Also indicated is a battery pack 20 that is provided within the PDA interface device 10B. The external power connector 18 for a DC power source is also provided on the underside of the interface device 10B. FIG.10 is a schematic illustration of the PDA interface device 10B. In this illustration, the PDA connector 25 is using only 4 pins of the multi-mode connector.

The embodiments of the invention mentioned herein are merely illustrative of the present invention. It should be understood that a person skilled in the art may contemplate many variations in construction of the present invention in view of the following claims without straying from the intended scope and field of the invention herein disclosed.

What is claimed is:

1. An interface device for mating with a universal GPS receiver having a GPS-receiver connector, said device comprising:
a housing that includes a support means for supporting said universal GPS receiver;
a device connector mounted in said housing so as to mate with and establish a functional connection when said universal GPS receiver is mounted in said support means;
an added-function circuit that is electronically connected to said device connector, said added-function circuit providing a functionality of an additional electronic device; and
a power module that provides power to said device connector and said added-function circuit;
wherein, when said universal GPS receiver is mounted in said support means, said power module provides power to said universal GPS receiver via said device connector and said universal GPS receiver transmits data to said added-function circuit.

2. The interface device of claim 1, wherein said device connector is a multi-mode connector for transmitting USB and/or RS-232 signals.

3. The interface device of claim 1, wherein said power module includes an on/off switch that controls power to said universal GPS receiver.

4. The interface device of claim 1, wherein said power module includes a battery pack.

5. The interface device of claim 3, wherein said power module further includes an external power connector for connecting said power module to an external power source.

6. The interface device of claim 4, further including a voltage switch for switching to said external power connector.

7. The interface device of claim 1, wherein said functionality is that of a wireless capability for transitting data received from said universal GPS receiver to an external device.

8. The interface device of claim 1, wherein said functionality is that of a data logger for logging data received from said universal GPS receiver.

9. The interface device of claim 1 further comprising an external-device connector that is functionally connected with said device connector, said external-device connector transmitting data from said universal GPS receiver and/or from said added-function circuit to an external device.

10. The interface device of claim 9, wherein said external-device connector is a multi-mode connector, capable of transmitting USB and/or RS-232 signals.

11. The interface device of claim 1, wherein an attachment means is provided on said housing.

12. The interface device of claim 11, wherein said attachment means is a clip.

13. The interface device of claim 12, wherein said attachment means is a suction cup.

14. The interface device of claim 1, wherein said support means includes a support bed recessed in an upper surface of said housing.

15. The interface device of claim 1, wherein said support means includes a support rail, and wherein a said universal GPS receiver has a surface that is adapted to receive said support rail.

16. A GPS-data unit comprising:
a universal GPS receiver;
said interface device of claim 1; and
a GPS cable that connects at a first end to said device connector of said interface device and at a second end to said GPS-receiver connector.

17. A GPS-data unit comprising:
a universal GPS receiver;
said interface device of claim 1; and
a PDA cable that connects at a first end to said device connector of said interface device and at a second end to an external PDA.
